(19) United States
(12) Patent Application Publication
(10) Pub. No.: US 2024/0251798 A1
(43) Pub. Date: Aug. 1, 2024

(54) ANTIVIRAL AND ANTIBACTERIAL FILM

(71) Applicant: YJ LAB Co., Ltd., Seoul (KR)

(72) Inventors: Dong Seop Shim, Uiwang-si (KR); Young Jo Park, Seoul (KR); Jin Young Choi, Gyeongsan-si (KR); Yun Seo Baek, Daegu (KR)

(21) Appl. No.: 18/190,539

(22) Filed: Mar. 27, 2023

(30) Foreign Application Priority Data
Jan. 31, 2023 (KR) 10-2023-0012315

(51) Int. Cl. A01N 59/20; A01N 25/34

(52) U.S. Cl. CPC A01N 59/20; A01N 25/34

(57) ABSTRACT

Disclosed is an antiviral and antibacterial master chip, an antiviral and antibacterial film, and a method for preparing the same, and a film harmless to humans and exhibiting excellent antiviral and antibacterial effects semi-permanently can be provided according to the present disclosure.

### CROSS-REFERENCE TO RELATED PATENT APPLICATION

This application claims the benefit of Korean Patent Application No. 10-2023-0012315, filed Jan. 31, 2023, the disclosure of which is incorporated herein in its entirety by reference.

### BACKGROUND

### Technical Field

The present disclosure relates to an antiviral and antibacterial film, and more particularly, to an antiviral and antibacterial film formed of an antiviral and antibacterial masterbatch chip with metal nanoparticles and hydroxyapatite nanoparticles deposited on a surface of a polymer chip.

### Background Art

Humans have always been at a constant battle with bacteria and viruses, but with the emergence of the COVID-19 virus, people are now more acutely aware of the dangers of diseases caused by bacteria and viruses. Accordingly, the demand for antibacterial protection in public spaces where there is frequent contact with others has increased rapidly, and with the diversification of living environments, there is a growing demand for various types of antibacterial and antiviral films that can remain active for long periods of time on all interior materials, daily necessities, indoor goods, IT products, and various medical environments. Moreover, with the increased awareness of chemical substances due to incidents such as the humidifier disinfectant scandal and growing concerns about antibiotic and antiviral resistance due to misuse and abuse of antibiotics and antivirals, demands for antiviral and antibacterial films highly effective yet harmless to humans are increasing. In fact, the global antibacterial coating market is on the rise from $2.29 billion in 2016 at an average annual growth rate of 14.22%.

Meanwhile, the above-described background technology corresponds to technical information that has been possessed by the present inventor in order to contrive the present disclosure or that has been acquired in the process of contriving the present disclosure, and cannot be necessarily viewed as a well-known technology that had been known to the public before the filing of the present disclosure.

### RELATED DOCUMENT

### Patent Document

(Patent Document 0001) Korea Patent Application Publication No. 2020-0083733

### SUMMARY

The present disclosure provides an antiviral and antibacterial film using antiviral and antibacterial masterbatch chips.

Objectives of the present disclosure and the merits thereof will be more apparent with reference to the following disclosure of preferred exemplary embodiment.

In one aspect, there is provided an antiviral and antibacterial film having a film layer that is formed of a masterbatch chip with metal nanoparticles deposited on a surface of a polymer chip and a masterbatch chip with hydroxyapatite nanoparticles deposited on a surface of a polymer chip.

The objective may be achieved by a method for preparing an antiviral and antibacterial film, the method including: a first step of preparing metal nanoparticles and hydroxyapatite nanoparticles; a second step of preparing a masterbatch chip with metal nanoparticles deposited on a surface of a polymer chip and a masterbatch chip with hydroxyapatite nanoparticles deposited on a surface of a polymer chip by depositing the metal nanoparticles and the hydroxyapatite particles on the surfaces of the polymer chips; a third step of preparing an antiviral and antibacterial film layer by heating, melting, and injecting of the chips; a fourth step of laminating a polymer substrate and a film layer prepared in the third step.

The above object can be solved by an antiviral and antibacterial masterbatch chip in which metal nanoparticles or hydroxyapatite nanoparticles are deposited on a surface of a polymer chip.

The objective may be achieved by a method for preparing an antiviral and antibacterial film, the method including: a first step of preparing metal nanoparticles and hydroxyapatite nanoparticles; and a second step of preparing a masterbatch chip with metal nanoparticles deposited on a surface of a polymer chip and a masterbatch chip with hydroxyapatite nanoparticles deposited on a surface of a polymer chip by depositing the metal nanoparticles and the hydroxyapatite particles on the surfaces of the polymer chips.

### DESCRIPTION OF EXEMPLARY EMBODIMENTS

Hereinafter, the present disclosure will be described in detail with reference to examples of the present disclosure. These examples are only exemplary to explain the present disclosure in more detail, and it will be apparent to those skilled in the art that the scope of the present disclosure is not limited by these examples.

In addition, unless otherwise defined, all terms including technical and scientific terms used herein have the same meanings as those commonly understood by one of ordinary skill in the art to which the present disclosure belongs, and in the case where the meanings thereof conflict, the description including the definitions herein shall prevail.

When a certain component is said to “include”, this means that it may further include other components, not excluding other components unless otherwise stated.

Ordinals (first, second, etc.) in individual steps are used for the sake of convenience in description and do not describe an order of the operations, and the individual steps may be performed differently from the described order unless the specific order is explicitly stated in context. That is, the individual steps may be performed in the described order or in the reverse order, or may be substantially simultaneously conducted.

An antiviral and antibacterial film according to an embodiment of the present disclosure may include a film layer that is formed of a masterbatch chip with metal nanoparticles deposited on a surface of a polymer chip and a masterbatch chip with hydroxyapatite nanoparticles deposited on a surface of a polymer chip.

In one embodiment of the present disclosure, in the deposition, metal or hydroxyapatite vapor particles are generated while stirring polymer chips in a stirring tank with polymer chips contained therein and in a vacuum deposition chamber having a vapor deposition source, and the metal or hydroxyapatite vapor particles are attached directly to the polymer chips, but aspects of the present disclosure are not limited thereto. In this case, since the nanoparticles are attached directly to the polymer chips, there is an advantage in that a separate dispersion process and dispersing agent are not required.

In one embodiment of the present disclosure, it is preferable to adjust a speed of a screw stirring the polymer chips in the vacuum deposition chamber to 1 to 300 rpm, but aspects of the present disclosure is not limited thereto. When the speed of the screw is less than 1 rpm, the stirring is not sufficiently performed so the vapor particles are not uniformly attached to the surfaces of the polymer chips, and the polymer chips being stirred are scattered when the stirring speed exceeds 300 rpm.

A degree of vacuum in the vacuum deposition chamber is controlled by including an inert gas, and the inert gas may be argon (Ar), neon (Ne), N2, O2, CH4, or the like.

In one embodiment of the present disclosure, a deposition time may be 10 minutes to 20 hours. By adjusting the time, the concentration of nanoparticles in the polymer chips may be controlled.

In one embodiment of the present disclosure, by the aforementioned deposition, it is possible to prepare polymer chips with various nanoparticles deposited thereon, such as a polymer chip with metal nanoparticles deposited thereon and a polymer chip with hydroxyapatite nanoparticles deposited thereon, and in this case, it is possible to adjust the speed of the screw and the deposition time according to physical properties of each particle.

In the step of generating vapor particles using the deposition source to form nanoparticles, a physical vapor deposition method may be used, for example, thermal evaporation such as a resistance heating method, a plasma heating method, an induction heating method, and a laser heating method, DC sputtering, DC-RF sputtering, laser sputtering, and E-Beam Evaporation.

In one embodiment of the present disclosure, a polymer used in the preparation of a polymer chip with nanoparticles deposited may be any polymer capable of being injection-molded, but may be preferably a thermoplastic polymer. More preferably, Linear low-density polyethylene (LLDPE), Low-density polyethylene (LDPE), High-density polyethylene (HDPE), Polypropylene (PP), Acrylonitrile-butadiene-styrene (ABS), Polysulfone (PS), Polycarbonate (PC), Polyvinylchloride (PVC), Polyethylene terephthalate (PET), and the like may be used. More preferably, it may be, but not limited to, LLDPE or LDPE. A size of the polymer chip is not limited, but is preferably 1 to 5 mm, more preferably 2 to 3 mm.

In one embodiment of the present disclosure, the metal may be any nanoparticles of a metal having antiviral and antibacterial capabilities, preferably metals such as copper, silver, zinc, brass, bronze, etc., and preferably, metals such as copper, silver, zinc, brass, and bronze may be used, more preferably, copper or silver may be used, and even more preferably, copper and silver may be used simultaneously, but it is not limited thereto.

In one embodiment of the present disclosure, in a case where copper and silver are simultaneously used as the metal, a film layer of the antiviral and antibacterial film may be formed of a masterbatch chip with copper nanoparticles deposited on a surface of a polymer chip, a masterbatch chip with silver nanoparticles deposited on a surface of a polymer chip, and a masterbatch chip with hydroxyapatite nanoparticles deposited on a surface of a polymer chip. In this case, the masterbatch chip with copper nanoparticles deposited on the surface of the polymer chip, the masterbatch chip with silver nanoparticles deposited on the surface of the polymer chip, and the masterbatch chip with hydroxyapatite nanoparticles deposited on the surface of the polymer chip may preferably have a weight ratio of 5 to 15:1:1 to 5, more preferably have a weight ratio of 7 to 10:1:3 to 4, and even more preferably have a weight ratio of 7:1:4 or 10:1:3, but aspects of the present disclosure are not limited thereto.

In one embodiment of the present disclosure, based on 100 parts by weight of the film layer, the film layer may include 30 to 85% by weight of metal nanoparticles and 10 to 40% by weight of hydroxyapatite nanoparticles. Preferably, 30 to 75% by weight of copper nanoparticles may include 3.75 to 10% by weight of silver nanoparticles and 10 to 40% by weight of hydroxyapatite nanoparticles, but aspects of the present disclosure are not limited thereto.

An average size of the nanoparticles is 2 to 30 nm, preferably 2 to 10 nm. In a case where the nanoparticles are formed in the above size, agglomeration of nanoparticles may be inhibited and well dispersed in polymer melt, thereby preparing a polymer film with the nanoparticles well dispersed.

An antiviral and antibacterial film according to an embodiment of the present disclosure exhibits a microbicidal effect against various microorganisms. For example, there are antiviral and antibacterial effects against Staphylococcus aureus, Escherichia coli, Psedomonas aeruginosa and Salmonella typhimurium, influenza virus, human corona virus, COVID-19 virus, and the like, but aspects of the present disclosure are not limited thereto.

Hydroxyapatite is an inorganic material with the same composition as that of mineral of human bone, and has been used as a medical biomaterial based on its high bio-compatibility and bio-adaptability.

The film layer of the antiviral and antibacterial film according to an embodiment of the present disclosure may be formed of: a masterbatch chip with metal nanoparticles deposited on a surface of a polymer chip; a masterbatch chip with hydroxyapatite particles deposited on a surface of a polymer chip; a masterbatch chip with hafnium oxide nanoparticles deposited on a surface of a polymer chip; a masterbatch chip with stainless steel nanoparticles deposited on a surface of a polymer chip; and a masterbatch chip with wollastonite nanoparticles deposited on a surface of a polymer chip.

In one embodiment of the present disclosure, when the masterbatch chip with metal nanoparticles deposited on the surface of the polymer chip, the masterbatch chip with hydroxyapatite particles deposited on the surface of the polymer chip, the masterbatch chip with hafnium oxide nanoparticles deposited on the surface of the polymer chip, the masterbatch chip with stainless steel nanoparticles deposited on the surface of the polymer chip, and the masterbatch chip with wollastonite nanoparticles deposited on the surface of the polymer chip are mixed in the same ratio, an antiviral and antibacterial effect may be maximized.

In one embodiment of the present disclosure, the film layer of the antiviral and antibacterial film may be formed of: a masterbatch chip with copper nanoparticles deposited on a surface of a polymer chip; a masterbatch chip with silver nanoparticles deposited on a surface of a polymer chip; a masterbatch chip with hydroxyapatite nanoparticles deposited on a surface of a polymer chip; a masterbatch chip with hafnium oxide nanoparticles deposited on a surface of a polymer chip; a masterbatch chip with stainless steel nanoparticles deposited on a surface of a polymer chip; and a masterbatch chip with wollastonite nanoparticles deposited on a surface of a polymer chip. In this case, the masterbatch chip with copper nanoparticles deposited on the surface of the polymer chip, the masterbatch chip with silver nanoparticles deposited on the surface of the polymer chip, the masterbatch chip with hydroxyapatite nanoparticles deposited on the surface of the polymer chip, the masterbatch chip with hafnium oxide nanoparticles deposited on the surface of the polymer chip, the masterbatch chip with stainless steel nanoparticles deposited on the surface of the polymer chip, and the masterbatch chip with wollastonite nanoparticles deposited on the surface of the polymer chip may preferably have a weight ratio of 5 to 15:1:1 to 5:1:1:1, more preferably a weight ratio of 7 to 10:1:3 to 4:1:1:1, and even more preferably a weight ratio of 7:1:4:1:1:1 or 10:1:3:1:1:1, but aspects of the present disclosure are not limited thereto.

In one embodiment of the present disclosure, based on 100 parts by weight of the film layer, the film layer may include 30% to 75% by weight of copper nanoparticles, 3.75% to 10% by weight of silver nanoparticles, 10 to 40% by weight of hydroxyapatite nanoparticles, 1.75% to 8% by weight of hafnium oxide nanoparticles, 1.75% to 8% by weight of stainless steel nanoparticles, and 1.75% to 8% by weight of wollastonite nanoparticles, but aspects of the present disclosure are not limited thereto.

In one embodiment of the present disclosure, the film layer of the antiviral and antibacterial film may be formed by using a masterbatch chip with silver nitrate nanoparticles deposited on a surface of a polymer chip in addition to the above-described nanoparticles.

In one embodiment of the present disclosure, the film layer of the antiviral and antibacterial film may be formed by using a masterbatch chip with titanium dioxide nanoparticles deposited on a surface of a polymer chip in addition to the masterbatch chip with the above-described nanoparticles deposited on a surface of a polymer chip.

In one embodiment of the present disclosure, the film layer of the antiviral and antibacterial film may be formed by using a masterbatch chip with SiO2 nanoparticles deposited on a surface of a polymer chip in addition to the masterbatch chip with the above-described nanoparticles deposited on a surface of a polymer chip.

In one embodiment of the present disclosure, the film layer of the antiviral and antibacterial film may be formed by using a masterbatch chip with cobalt-chromium alloy nanoparticles deposited on a surface of a polymer chip in addition to the masterbatch chip with the above-described nanoparticles deposited on a surface of a polymer chip.

In one embodiment of the present disclosure, the film layer of the antiviral and antibacterial film may be formed by using a masterbatch chip with silver nitrate carbonate apatite particles deposited on a surface of a polymer chip in addition to the masterbatch chip with the above-described nanoparticles deposited on a surface of a polymer chip.

In one embodiment of the present disclosure, the film layer of the antiviral and antibacterial film may be formed by using a masterbatch chip with zirconia nanoparticles deposited on a surface of a polymer chip in addition to the masterbatch chip with the above-described nanoparticles deposited on a surface of a polymer chip.

In one embodiment of the present disclosure, the film layer of the antiviral and antibacterial film may be formed by using a masterbatch chip with whitlockite nanoparticles deposited on a surface of a polymer chip in addition to the masterbatch chip with the above-described nanoparticles deposited on a surface of a polymer chip.

The antiviral and antibacterial film according to an embodiment of the present disclosure may further include a polymer substrate layer distinct from the film layer.

In one embodiment of the present disclosure, the polymer substrate layer may be of PE, PET, OPP, PVC, PS, nylon, HDPE, and the like, preferably of PE, but aspects of the present disclosure not limited thereto.

In one embodiment of the present disclosure, a thickness of the film layer may be 1 to 20 μm, preferably 5 to 20 μm, more preferably 5 to 15 μm, and most preferably 5 μm. to 10 μm, but aspects of the present disclosure are not limited thereto. When the thickness of the film layer falls within the aforementioned numerical range, metal ions may be exposed to bacteria and viruses at maximum, thereby maximizing an antiviral and antibacterial effect.

In one embodiment of the present disclosure, the polymer substrate layer may have a thickness of 50 to 200 μm, preferably 50 to 150 μm, and more preferably 100 to 130 μm, but aspects of the present disclosure are not limited thereto.

The antiviral and antibacterial film according to an embodiment of the present disclosure may be a non-adhesive film, and in a case where the antiviral and antibacterial film is a non-adhesive film, the antiviral and antibacterial film according to the present disclosure consists of a film layer and a polymer substrate layer.

The antiviral and antibacterial film according to an embodiment of the present disclosure may be an adhesive film, and in a case where the antiviral and antibacterial film is an adhesive film, the antiviral and antibacterial film according to the present disclosure may include an adhesive layer and a release paper layer in addition to a film layer and a polymer substrate layer. There is no limit to the type of an adhesive layer as long as pressure-sensitive adhesive (PSA) is used, and there is no limit to the type of a release paper, but the release paper leaving no air bubbles, easily attachable, and leaving no adhesive layer on a target surface at a time of detachment of the film is most preferable.

In one embodiment of the present disclosure, for the film layer, a thin film having nanoparticles may be obtained by inserting a prepared masterbatch chip into an extruder, and heating, melting, and extruding the masterbatch chip.

In the injection, one or more masterbatch chip selected from a group of: the masterbatch chip with metal nanoparticles deposited on a surface of a polymer chip; the masterbatch chip with hydroxyapatite particles deposited on a surface of a polymer chip; the masterbatch chip with hafnium oxide nanoparticles deposited on a surface of a polymer chip; the masterbatch chip with stainless steel nanoparticles deposited on a surface of a polymer chip; and a masterbatch chip with wollastonite nanoparticles deposited on a surface of a polymer chip may be mixed and used.

In this case, when the film is prepared with a thin thickness, a surface area compared to a volume is increased, so that even when a small amount of metal is added, a large amount of metal is exposed on the surface, thereby providing a high antiviral and antibacterial effect. A temperature for melting the masterbatch chips may be 100° C. or more, preferably 150 to 300° C., more preferably 150 to 200° ° C., but aspects of the present disclosure are not limited thereto.

In one embodiment of the present disclosure, the polymer substrate layer is formed by laminating a polymer substrate having mechanical strength with an antiviral and antibacterial film layer. The lamination may be performed using a laminating method and may use a dry method or a T-die method. The lamination may be performed in a method of compressing two or more types of polymer films by heating a roller. In this case, a separate adhesive and/or solvent may be used or laminated using PE.

A method for preparing an antiviral and antibacterial film according to an embodiment of the present disclosure may include: (1) a first step of preparing metal nanoparticles and hydroxyapatite particles: (2) a second step of preparing a masterbatch chip with metal nanoparticles deposited on a surface of a polymer chip and a masterbatch chip with hydroxyapatite nanoparticles deposited on a surface of a polymer chip by depositing the metal nanoparticles and the hydroxyapatite particles on the surfaces of the polymer chips; (3) a third step of preparing an antiviral and antibacterial film layer by heating, melting, and injecting of the chips; and (4) a fourth step of laminating a polymer substrate and a film layer prepared in the third step.

In one embodiment of the present disclosure, the third step is a step of obtaining a thin polymer film having nanoparticles by inserting and injecting the prepared masterbatch chips into an extruder.

In the injection, one or more masterbatch chip selected from a group of: the masterbatch chip with metal nanoparticles deposited on a surface of a polymer chip; the masterbatch chip with hydroxyapatite particles deposited on a surface of a polymer chip; the masterbatch chip with hafnium oxide nanoparticles deposited on a surface of a polymer chip; the masterbatch chip with stainless steel nanoparticles deposited on a surface of a polymer chip; and the masterbatch chip with wollastonite nanoparticles deposited on a surface of a polymer chip may be mixed and used.

In this case, when the film is prepared with a thin thickness, a surface area compared to a volume is increased, so that even when a small amount of metal is added, a large amount of metal is exposed on the surface, thereby providing a high antiviral and antibacterial effect. A temperature for melting the masterbatch chips may be 100° C. or more, preferably 150 to 300° ° C., more preferably 150 to 200° C., but aspects of the present disclosure are not limited thereto.

In one embodiment of the present disclosure, the fourth step is a step of laminating the polymer substrate having mechanical strength and the antiviral and antibacterial film layer prepared in the third step. The lamination may be performed using a laminating method and may use a dry method or a T-die method. The lamination may be performed in a method of compressing two or more types of polymer films by heating a roller. In this case, a separate adhesive and/or solvent may be used or laminated using PE.

In one embodiment of the present disclosure, the antiviral and antibacterial film may be a non-adhesive or adhesive film. The non-adhesive film may be prepared by performing up to the above-mentioned fourth step. An adhesive film may be prepared by further performing (5) a fifth step of forming an adhesive layer with an adhesive composition on the opposite side of a side of the polymer substrate layer adjacent to the film layer, and (6) a sixth step of forming a release paper layer on the opposite side of a side of the adhesive layer adjacent to the polymer substrate layer.

In the antiviral and antibacterial masterbatch chip for preparing an antiviral and antibacterial film according to an embodiment of the present disclosure, metal nanoparticles or hydroxyapatite nanoparticles may be deposited on a surface of a polymer chip.

A method for preparing an antiviral and antibacterial masterbatch chip may include: (1) a first step of preparing metal nanoparticles and hydroxyapatite nanoparticles; and (2) a second step of preparing a masterbatch chip with metal nanoparticles deposited on a surface of a polymer chip and a masterbatch chip with hydroxyapatite nanoparticles deposited on a surface of a polymer chip by depositing the metal nanoparticles and the hydroxyapatite particles on the surfaces of the polymer chips.

In the antiviral and antibacterial masterbatch chip, a masterbatch chip may be with hafnium oxide nanoparticles deposited on a surface of a polymer chip, a masterbatch chip may be with stainless steel nanoparticles deposited on a surface of a polymer chip, and wollastonite nanoparticles may be deposited on a surface of a polymer chip.

When hafnium oxide, stainless steel, and wollastonite, rather than metal or hydroxyapatiteare, are deposited on a surface of a polymer chip, a masterbatch chip with the materials deposited on the polymer chip may be prepared.

Hereinafter, the configuration of the present disclosure and effects thereof will be described in more detail through specific examples and comparative examples. However, these examples are for explaining the present disclosure in more detail, and the scope of the present disclosure is not limited to these examples.

### EXAMPLES

### Example 1. Preparation of Antiviral and Antibacterial Masterbatch Chips with Hydroxyapatite and Metal Deposited Thereon

1-1. Preparation of Masterbatch Chip with Copper Nanoparticle Deposited Thereon

A disk-type copper (Cu) target having a diameter of 10 cm and a thickness of 1 cm was attached to a DC sputtering cathode. After a polymer LDPE chip was put into a stirring tank in a vacuum chamber, a door of the vacuum chamber was closed and vacuum exhaust was started. A low vacuum state of 1×10−2 Torr was made using a rotary pump, and a high vacuum state of below 1×10−4 Torr was made using an oil diffusion pump. In the high vacuum state, argon gas was injected into the vacuum chamber at a flow rate of 50 to 150 sccm, and the polymer chip was stirred at a speed of 100 rpm. The injection of the argon gas was to generate plasma for deposition, and stirring of the polymer chip was to maintain the deposited particles in a fine size without coarsening. When DC power was applied, plasma was generated and metal particles were deposited. The deposition time is 20 hours. After a masterbatch chip mixture treated as described above was stirred and melted at a temperature of 150 to 200° C., the masterbatch chip mixture was cooled to room temperature. After the cooled polymer chip mixture was extruded and then water-cooled and dried, a masterbatch chip was prepared by cutting and drying the polymer chip mixture with a rotary knife.

1-2. Preparation of a Masterbatch Chip with Silver Nanoparticles Deposited Thereon

A masterbatch chip with silver nanoparticles deposited thereon was prepared in the same manner as in 1-1, except that a silver target was used, a stirring speed of a polymer chip was set to 150 rpm, and a deposition time was set to 15 hours.

1.3 Preparation of a Masterbatch Chip with Hydroxyapatite Nanoparticles Deposited Thereon

A masterbatch chip with hydroxyapatite nanoparticles deposited thereon was prepared in the same manner as in 1-1, except that a hydroxyapatite target was used, a stirring speed was 200 rpm, and a deposition time was 10 hours.

1-4. Preparation of a Masterbatch Chip with Hafnium Oxide Nanoparticles Deposited Thereon

A masterbatch chip with hafnium oxide nanoparticles deposited thereon was prepared in the same manner as in 1-1, except that a hafnium oxide target was used, a stirring speed was 250 rpm, and a deposition time was 20 hours.

1-5. Preparation of a Masterbatch Chip with Stainless Steel Nanoparticles Deposited Thereon

A masterbatch chip with stainless steel nanoparticles deposited thereon was prepared in the same manner as in 1-1, except that a stainless steel target was used, a stirring speed was 170 rpm, and a deposition time was 8 hours.

1-6. Preparation of a Masterbatch Chip with Wollastonite Nanoparticles Deposited Thereon

A masterbatch chip with wollastonite nanoparticles deposited thereon was prepared in the same manner as in 1-1, except that a wollastonite target was used, a stirring speed was 300 rpm, and a deposition time was 16 hours.

### Example 2. Preparation of an Antiviral and Antibacterial Film Using Antiviral and

Antibacterial Masterbatch Chips

### 2-1. Preparation of a Non-Adhesive Film

The masterbatch chips prepared in Examples 1-1 to 1-6 were mixed in the weight ratio shown in Table 1 to prepare the respective films of Examples 2-1 to 2-8, and the thickness of the prepared films was 0.01 mm. A film preparing condition is that the masterbatch chips are melted by heating to about 150 to 200° C. in a polymer film injection container for blow molding and then injected at room temperature in the air. The prepared film layer was laminated with a polyethylene polymer substrate layer using a laminating method to thereby prepare an antiviral and antibacterial film of 0.13 mm.

### 2-2. Preparation of an Adhesive Film

In the polyethylene polymer substrate layer of the film prepared in Example 2-1, a pressure-sensitive adhesive was applied to the opposite side of a side adjacent to the film layer to form an adhesive layer. After a release paper (which requires a release force of 1 gf/inch to 100 gf/inch) is attached on the opposite side of the side adjacent to the polyethylene polymer substrate layer of the adhesive layer, the opposite side with the release paper attached thereon were left at 20° C. for 10 days to prepare an antiviral and antibacterial film (Example 2-9) having a thickness of 0.16 mm (excluding the thickness of the release paper).

TABLE 1

| | Example | Example | Example | Example | Example | Example |
|---|---|---|---|---|---|---|
| Types | 1-1 | 1-2 | 1-3 | 1-4 | 1-5 | 1-6 |
| Example 2-1 | 7 | 1 | 4 | — | — | — |
| Example 2-2 | 7 | 1 | 4 | 1 | 1 | 1 |
| Example 2-3 | 7 | 1 | 4 | 2 | 1 | 1 |
| Example 2-4 | 7 | 1 | 4 | 1 | 2 | 1 |
| Example 2-5 | 10 | 1 | 3 | — | — | — |
| Example 2-6 | 10 | 1 | 3 | 1 | 1 | 1 |
| Example 2-7 | 10 | 1 | 3 | 2 | 1 | 1 |
| Example 2-8 | 10 | 1 | 3 | 1 | 2 | 1 |
| Example 2-9 | 7 | 1 | 4 | 1 | 1 | 1 |

### Test Example 1. Antibacterial Test

An antibacterial test for bacterial reduction was performed according to ISO 22196 and JIS Z 2801. The bacteria used in the test were Staphylococcus aureus (ATCC 6538), Escherichia coli (ATCC 11229 or ATCC 10536), Pseudomonas aeruginosa (ATCC 15522), and Salmonella typhimurium (ATCC 13311). As for a test site, the test was conducted in a clean bench suitable for sterility testing in a separate space, and the tools used for the test were maintained in a sterilized state. An inhibition rate between each experiment group (a film prepared by bacterial solution/example) left for 1 to 5 minutes and a control group (bacterial solution) was calculated as follows.

Inhibition rate (%)=[number of bacteria in the control group (CFU)−number of bacteria in the experiment group (CFU)]/number of bacteria in the control group (CFU)×100

The number of colonies formed in each group was counted, and the antibacterial activity (%) of an experiment group treated with the film prepared in the example was calculated in comparison with the control group not treated with the film prepared in the example, and then shown in Table 2.

TABLE 2

| | Types | | | |
|---|---|---|---|---|
| | Escherichia | Staphylococcus | Salmonella | Pseudomonas |
| | coli | aureus | typhimurium | aeruginosa |
| Example | 99.999% | 99.999% | 99.999% | 99.999% |
| 2-1 | antibacterial | antibacterial | antibacterial | antibacterial |
| Example | 99.999% | 99.999% | 99.999% | 99.999% |
| 2-2 | antibacterial | antibacterial | antibacterial | antibacterial |
| Example | 99.999% | 99.999% | 99.999% | 99.999% |
| 2-3 | antibacterial | antibacterial | antibacterial | antibacterial |
| Example | 99.999% | 99.999% | 99.999% | 99.999% |
| 2-4 | antibacterial | antibacterial | antibacterial | antibacterial |
| Example | 99.999% | 99.999% | 99.999% | 99.999% |
| 2-5 | antibacterial | antibacterial | antibacterial | antibacterial |
| Example | 99.999% | 99.999% | 99.999% | 99.999% |
| 2-6 | antibacterial | antibacterial | antibacterial | antibacterial |
| Example | 99.999% | 99.999% | 99.999% | 99.999% |
| 2-7 | antibacterial | antibacterial | antibacterial | antibacterial |
| Example | 99.999% | 99.999% | 99.999% | 99.999% |
| 2-8 | antibacterial | antibacterial | antibacterial | antibacterial |
| Example | 99.999% | 99.999% | 99.999% | 99.999% |
| 2-9 | antibacterial | antibacterial | antibacterial | antibacterial |

All films prepared by the examples exhibited very good antibacterial activity of 99.999% or more.

### Test Example 2. Antiviral Efficacy Evaluation

An antiviral test was performed by measuring titer of viruses proliferated according to a virus quantification method (TCID50 and Plaque assay) on the films prepared in Examples 2-1, 2-2, 2-6, 2-7, and 2-9, and the results are shown in Table 3 below. The viruses used in the test were influenza virus (IFV A/H1N1), human corona virus (hCoV-OC43), and two types of COVID-19 viruses (SARS-COV-2 Wuhan strain, Omicron mutant strain).

Plaque assay was performed for the two types of COVID-19 viruses, and an inhibition rate (%) was calculated and evaluated as follows. Plaque refers to a monolayer cell site where a cell has deformed due to viral infection. Normal cells around the plaque are stained purple by crystal violet, and monolayer cells with cell degeneration induced are distinguished as clear zones. The number of plaques is counted and expressed as plaque forming units (PFU)/mL.

For influenza virus and human corona virus, TCID50 assay was performed, and the inhibition rate (%) was calculated and evaluated as follows. In the TCID50 assay, after infection of cells with a 10-fold diluted virus, the cytopathic effect caused by the virus was verified 3 to 6 days later, and the TCID50 was calculated using the Spearman-Kärber method as a dilution rate that blocks the cytopathic effect at 50%.

TABLE 3

| | Types | | | |
|---|---|---|---|---|
| | | Human | COVID-19 | COVID-19 |
| | Influenza | Corona | SARS-CoV-2 | Omicron |
| | IFV A/H1N1 | hCoV-OC43 | Wuhan strain | mutant strain |
| Example 2-1 | 92% | 97% | 97% | 83% |
| Example 2-2 | 94% | 99% | 99% | 86% |
| Example 2-6 | 91% | 95% | 96% | 81% |
| Example 2-7 | 92% | 96% | 97% | 82% |
| Example 2-9 | 94% | 98% | 99% | 87% |

In the case of the antiviral and antibacterial films prepared by Examples 2-1, 2-2, 2-6, 2-7 and 2-9, the antiviral effect of 90% or more were observed against influenza and human corona virus, 96% or more against SARS-COV-2 Wuhan strain, and 80% or more against Omicron mutant strain.

According to the present disclosure, it is possible to provide a film that is harmless to humans and exhibit excellent antiviral and antibacterial effects.

According to the present disclosure, it is possible to provide a film that exhibits antiviral and antibacterial effects semi-permanently.

According to the present disclosure, it is possible to provide an antiviral and antibacterial film having excellent visibility of 75 or more transparency.

However, effects of the present disclosure are not limited to the effects mentioned above, and other effects not mentioned will be clearly understood by those skilled in the art from the description.

In this specification, only a few examples of various embodiments performed by the present inventors are described, but the technical spirit of the present disclosure is not limited or limited thereto, and can be modified and implemented in various ways by those skilled in the art, of course.

What is claimed is:

1. An antiviral and antibacterial film comprising a film layer that comprises a masterbatch chip having metal nanoparticles deposited on a surface of a polymer chip and a masterbatch chip having hydroxyapatite nanoparticles deposited on a surface of a polymer chip.

2. The antiviral and antibacterial film of claim 1, wherein to achieve the deposited nanoparticles, metal or hydroxyapatite vapor particles are generated while stirring polymer chips in a stirring tank with polymer chips contained therein and in a vacuum deposition chamber having a vapor deposition source, and the metal or hydroxyapatite vapor particles are attached directly to the polymer chips.

3. The antiviral and antibacterial film of claim 1, wherein a polymer of each polymer chip is one or more selected from a group of linear low density polyethylene (LLDPE), low density polyethylene (LDPE), high density polyethylene (HDPE), polypropylene (PP), acrylonitrile-butadiene-styrene (ABS), polysulfone (PS), polyethylene terephthalate (PET), and polycarbonate (PC).

4. The antiviral and antibacterial film of claim 1, wherein the metal is two or more selected from copper, silver, zinc, brass, and bronze.

5. The antiviral and antibacterial film of claim 1, wherein the antiviral and antibacterial film has an antiviral and antibacterial effect against one or more selected from Staphylococcus aureus, Escherichia coli, Psedomonas aeruginosa and Salmonella typhimurium, influenza virus, human corona virus, and COVID-19 virus.
